(19) United States
(12) Patent Application Publication
(10) Pub. No.: US 2017/0351298 A1
(43) Pub. Date: Dec. 7, 2017

(54) DETACHABLE ELECTRONIC DEVICE

(71) Applicant: ASUSTEK COMPUTER INC., Taipei (TW)

(72) Inventors: QING LI, TAIPEI (TW); WEAN-FONG LOI, TAIPEI (TW); KUAN-PEI LEE, TAIPEI (TW); CHUN-LUN LEE, TAIPEI (TW); JIAN-TING ALDEN KOH, TAIPEI (TW)

(21) Appl. No.: 15/609,960

(22) Filed: May 31, 2017

Related U.S. Application Data
(60) Provisional application No. 62/343,985, filed on Jun. 1, 2016.

(30) Foreign Application Priority Data
Mar. 29, 2017 (CN) 201710196962.2

(51) Int. Cl. G06F 1/16

(52) U.S. Cl. CPC G06F 1/1616; G06F 1/1681; G06F 1/1656; G06F 1/1669

(57) ABSTRACT

A detachable electronic device is provided. The detachable electronic device is adapted to a cover with a plurality of folding sections. The detachable electronic device comprises: a body including a first surface and a second surface and a peripheral unit detachably connected to the body and including a pivot portion. The first connector is disposed at the first surface. The pivot portion includes a fixing pivot member and a magnetic pivot member pivotally connected to the fixing pivot member and including a second connector. When the first connector is magnetically attached to the second connector and the body is supported by folding the folding sections of the cover, the pivot portion is raised up by a distance from a support surface against which the peripheral unit abuts.

### CROSS-REFERENCE TO RELATED APPLICATION

This application claims the priority benefit of U.S. provisional application Ser. No. 62/343,985, filed on Jun. 1, 2016 and CN application serial No. 201710196962.2, filed on Mar. 29, 2017. The entirety of the above-mentioned patent applications are hereby incorporated by references herein and made a part of specification.

### BACKGROUND OF THE INVENTION

### Field of the Invention

The disclosure relates to an electronic device and, more specifically, to a detachable electronic device.

### Description of the Related Art

Electronic devices are widely used in daily life and work. A keyboard is usually applied for text input. However, either a wired keyboard or a wireless keyboard exist shortcomings.

To apply the keyboard wireless, such a Bluetooth keyboard, a Bluetooth connection should be established first between the keyboard and the electronic device. Thus, it is inefficient for using keyboard wirelessly. However, to apply the keyboard wired, the electronic device cannot be portable since there is a physical wire connecting the keyboard and the electronic device, which is also inconvenient.

### BRIEF SUMMARY OF THE INVENTION

According to an aspect of the disclosure, a detachable electronic device is provided. The detachable electronic device is adapted to a cover with a plurality of folding sections. The detachable electronic device comprises a body and a peripheral unit. The body includes a first surface and a second surface. The peripheral unit is detachably connected to the body and includes a pivot portion. The first connector is disposed at the first surface.

The pivot portion includes a fixing pivot member and a magnetic pivot member. The magnetic pivot member is pivotally connected to the fixing pivot member and includes a second connector. When the first connector is magnetically attached to the second connector and the body is supported by folding the folding sections of the cover, the pivot portion is raised up by a distance from a support surface against which the peripheral unit abuts.

In embodiments of the detachable electronic device, the peripheral unit includes the pivot portion. Thus, the peripheral unit can be quickly attached and fixed to the first surface of the body via the pivot portion. The peripheral unit is electrically connected to the body. The peripheral unit is raised up from the support surface, which facilitates the operation of the peripheral unit.

### BRIEF DESCRIPTION OF THE DRAWINGS

These and other features, aspects and advantages of the disclosure will become better understood with regard to the following embodiments and accompanying drawings.

FIG. 1 is an exploded view of a detachable electronic device in an embodiment;

FIG. 2 is an exploded view of the detachable electronic device in FIG. 1 from a different perspective in an embodiment;

FIG. 3 is a planar exploded view of the detachable electronic device in FIG. 1 in an embodiment;

FIG. 4 is a planar assembly diagram showing the detachable electronic device in FIG. 1 in an embodiment;

FIG. 5 is a planar view showing a tablet computer rotates relative to an expansion device in the embodiment of FIG. 1;

FIG. 6 is a planar view showing the tablet computer is placed on the support surface to make a connecting end of the expansion device raise up in the embodiment of FIG. 1;

FIG. 7 is an enlarged view of a circle A in FIG. 6 in an embodiment;

FIG. 8 is a perspective view showing the tablet computer is placed on the support surface to make the connecting end of the expansion device raise up in the embodiment of FIG. 1;

FIG. 9 is a planar view of a detachable electronic device in an embodiment; and

FIG. 10 is a planar view of a detachable electronic device in an embodiment.

### DETAILED DESCRIPTION OF THE EMBODIMENTS

These and other features, aspects, and advantages of the disclosure will become better understood with regard to the following description, appended claims, and accompanying drawings. However, the embodiments are not limited herein. The description of the operation of components is not used for limiting the execution sequence. Any equivalent device with the combination according to the disclosure is in the scope of the disclosure. The components shown in figures are not used for limit the size or the proportion.

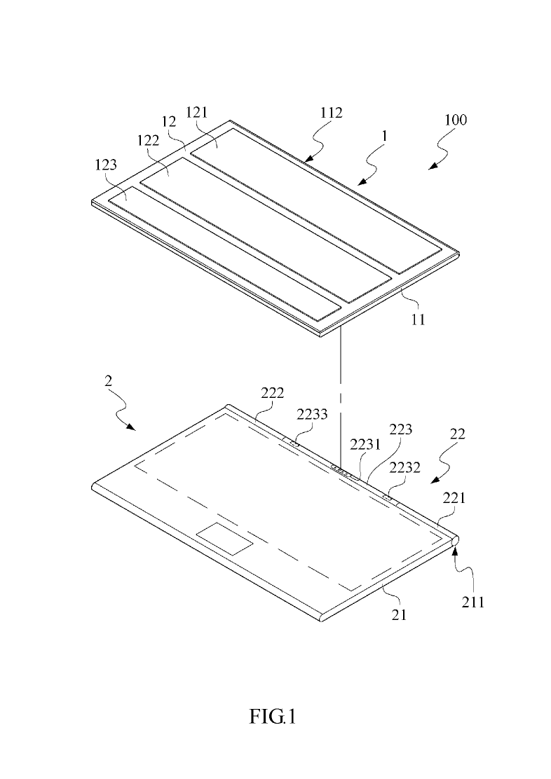

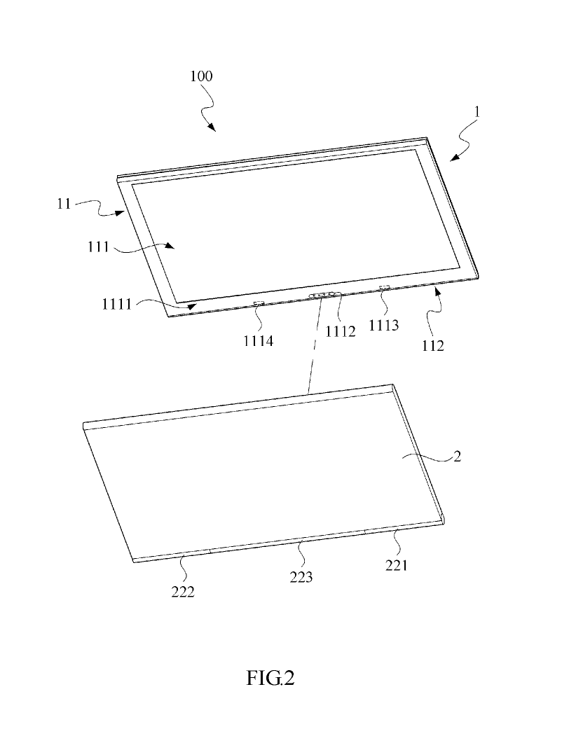

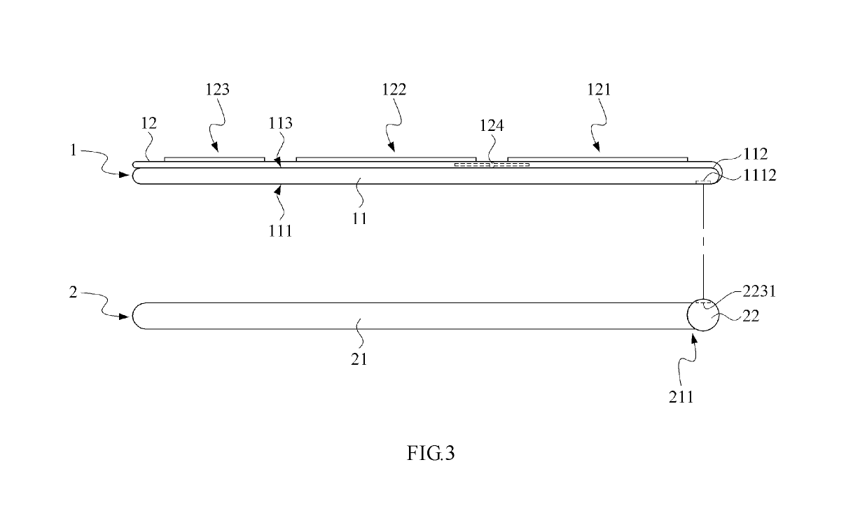

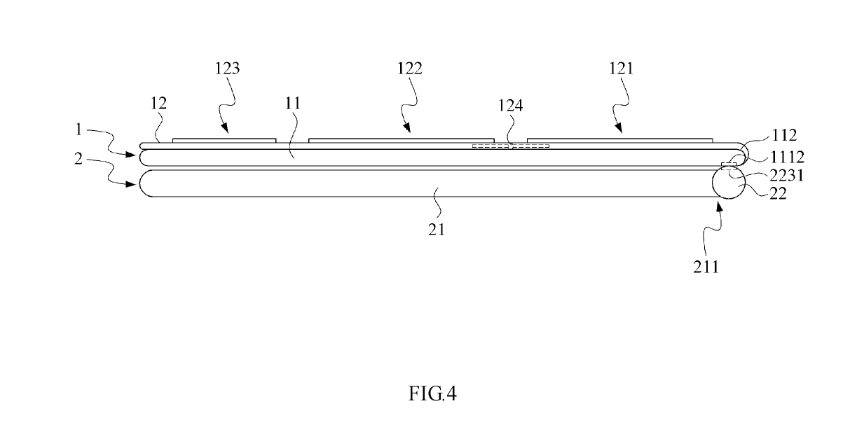

Please refer to FIG. 1 to FIG. 4. FIG. 1 is an exploded view of a detachable electronic device in an embodiment. FIG. 2 is an exploded view of the detachable electronic device in FIG. 1 from a different perspective in an embodiment. FIG. 3 is a planar exploded view of the detachable electronic device in FIG. 1 in an embodiment. FIG. 4 is a planar assembly diagram showing the detachable electronic device in FIG. 1 in an embodiment. As shown in the figures, in an embodiment, a detachable electronic device 100 includes a body 11 and a peripheral unit 2.

The detachable electronic device 100 is adapted to cooperate with a cover 12 with a plurality of folding sections. The detachable electronic device 100 includes the body 11 and the peripheral unit 2. The body 11 includes a first surface 111, a second surface 112 and a back surface 113 (as denoted in FIG. 3). A first connector 1112 and two frame magnetic elements 1113 and 1114 are disposed at a frame area 1111 of the first surface 111.

A second surface 112 is adjacent to the first surface 111. The back surface 113 is adjacent to the second surface 112. The back surface 113 is disposed opposite to the first surface 111.

The cover 12 includes folding sections 121, 122 and 123 and a hinge structure 124 (as denoted in FIG. 3). An end of the folding section 121 is fixedly connected to the second surface 112. The folding section 122 is foldably connected to the folding section 121. The folding section 123 is foldably connected to the folding section 122.

In an embodiment, the folding section 123 is a magnetic-attaching end folding section. The folding section 123 is magnetically attached to the back surface 113 of the body 11. The hinge structure 124 is disposed between the folding sections 121 and 122 to provide a torsional force between the folding sections 121 and 122. Thus, an angle between the folding sections 121 and 122 can be kept.

In an embodiment, the cover 12 is made of flexible materials (such as soft plastic, silica gel or leather). Rigid sheets, such as metal sheets or rigid plastic sheets are embedded inside the covering 12 to form the folding sections 121, 122 and 123.

In an embodiment, the hinge structure 124 is an elastic hinge structure. That is, a spring or an elastic element is configured in the hinge structure 124 to allow the connected folding sections 121 and 122 to form the angle therebetween. The angle between the folding sections 121 and 122 can be further adjusted by changing the positon that the folding section 123 is attached to the body 11. Then, tilt angles of the body 11 is changed.

In the embodiment, the hinge structure 124 is disposed between the folding sections 121 and 122. The folding section 123 is magnetically attached to the back surface 113 of the body 11. When the folding section 123 is magnetically attached to the back surface 113, with the foldable connections between any two of the folding sections 121, 122 and 123 and the torsional force from the hinge structure 124, a support structure is formed by the folding sections 121, 122 and 123 to support the body 11.

The peripheral unit 2 includes a peripheral unit body 21 and a pivot portion 22. The peripheral unit body 21 includes a connecting end portion 211. In an embodiment, the peripheral unit 2 is an expansion device, such as a speaker or an external keyboard. In the embodiment, the peripheral unit 2 is an external keyboard.

In an embodiment, the peripheral unit 2 further includes a keyboard module and a cursor operation module (not shown in the figures). The pivot portion 22 includes two fixing pivot members 221 and 222 and a magnetic pivot member 223.

The fixing pivot members 221 and 222 are fixed at two ends of the connecting end portion 211, respectively. The fixing pivot members 221 and 222 are electrically connected to the peripheral unit body 21, respectively. The magnetic pivot member 223 includes a second connector 2231 and two pivot magnetic elements 2232 and 2233. The pivot magnetic elements 2232 and 2233 correspond to the two frame magnetic elements 1113 and 1114, respectively.

The second connector 2231 is electrically connected to the fixing pivot members 221 and 222. When the magnetic pivot member 223 is magnetically attached to the frame magnetic elements 1113 and 1114 (that are disposed in the frame area 1111) via the pivot magnetic elements 2232 and 2233, the second connector 2231 is electrically connected to the first connector 1112. In an embodiment, the first connector 1112 and the second connector 2231 are magnetic electrical connectors, which makes the electrical connection between the first connector 1112 and the second connector 2231 more stable.

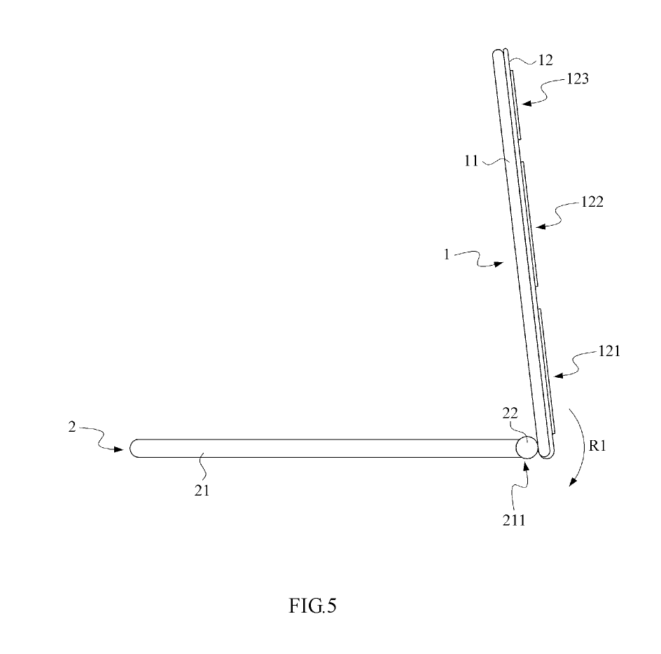

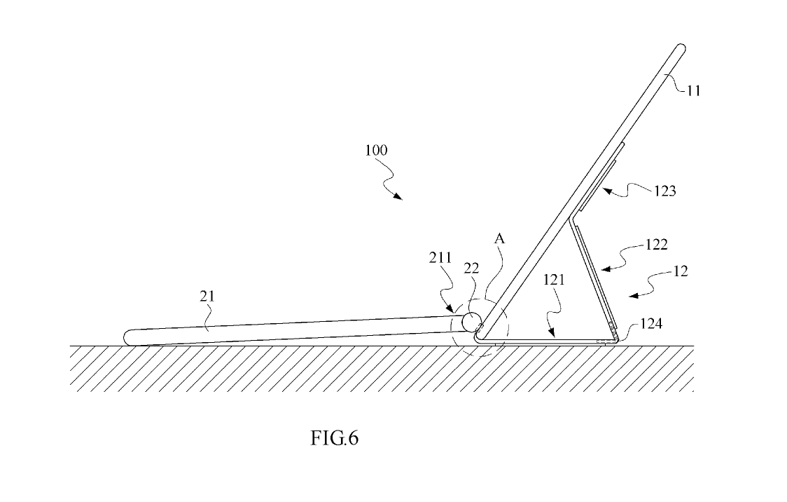

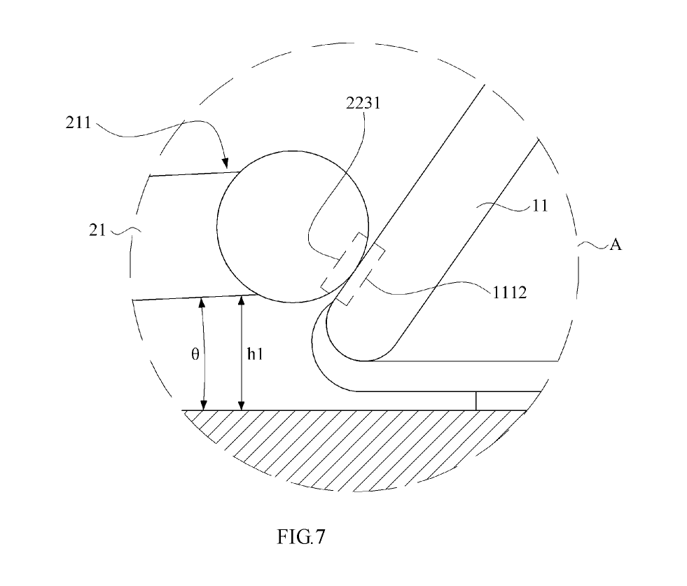

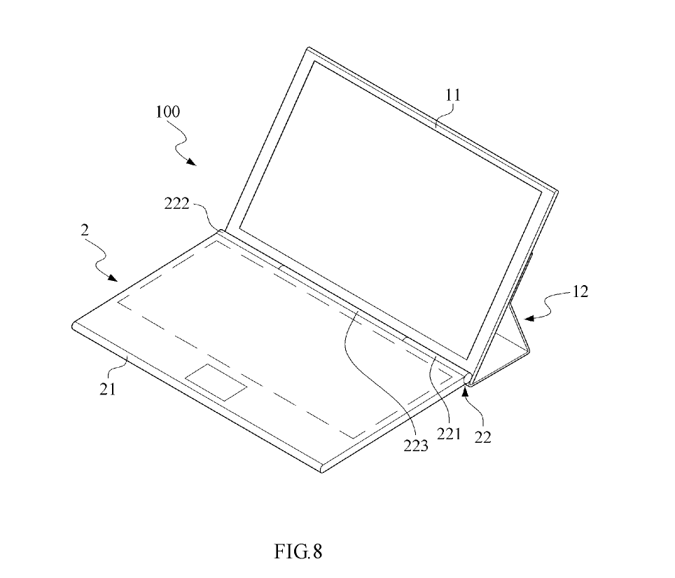

Please refer to FIG. 5 to FIG. 8. FIG. 5 is a planar view showing a tablet computer which rotates relative to an expansion device in the embodiment of FIG. 1. FIG. 6 is a planar view showing the tablet computer, which is placed on the support surface to make a connecting end of the expansion device raise up in the embodiment of FIG. 1. FIG. 7 is an enlarged view of a circle A in FIG. 6. FIG. 8 is a perspective view showing the tablet computer, which is placed on the support surface to make the connecting end of the expansion device raise up in the embodiment of FIG. 1.

As shown in the figures, after the body 11 is magnetically attached to the second connector 2231 and the pivot magnetic elements 2232 and 2233 via the first connector 1112 and the two frame magnetic elements 1113 and 1114, the body 11 rotates along a rotating direction R1. Thus, the magnetic pivot member 223 is driven by the body 11 to rotate relative to the two fixing pivot members 221 and 222.

In the embodiment, when the magnetic pivot member 223 is magnetically attached to the frame area 1111 of the body 11, the body 11 rotates to make the second surface 112 and the peripheral unit 2 abut against the support surface (not shown in the figures). Then, the connecting end portion 211 starts to be raised up from the support surface.

In the embodiment, the magnetic pivot member 223 is attached and fixed to the frame area 1111. Therefore, when the body 11 rotates along the rotating direction R1 and continues to rotate after the second surface 112 abuts against the support surface, the frame area 1111 where the magnetic pivot member 223 is attached moves below the magnetic pivot member 223. Thus, the connecting end portion 211 is driven to be raised up by the fixing pivot members 221 and 222 that are pivotally connected to the magnetic pivot member 223. Consequently, the peripheral unit body 21 is raised up by a height h1, and an angle θ is formed between the support surface and the peripheral unit body 21.

In the embodiments of the detachable electronic device 100, the pivot portion 22 is configured at the connecting end portion 211 of the peripheral unit body 21. Thus, the peripheral unit 2 can be quickly attached and fixed to the first surface 111 of the body 11 via the pivot portion 22. The body 11 is electrically connected to the peripheral unit body 21. The connecting end portion 211 of the peripheral unit body 21 is positioned at the frame area 1111 of the body 11, which allows the connecting end portion 211 of the peripheral unit body 21 to be raised up relative to the support surface. Thus, the operation of the peripheral unit body 21 is more convenient.

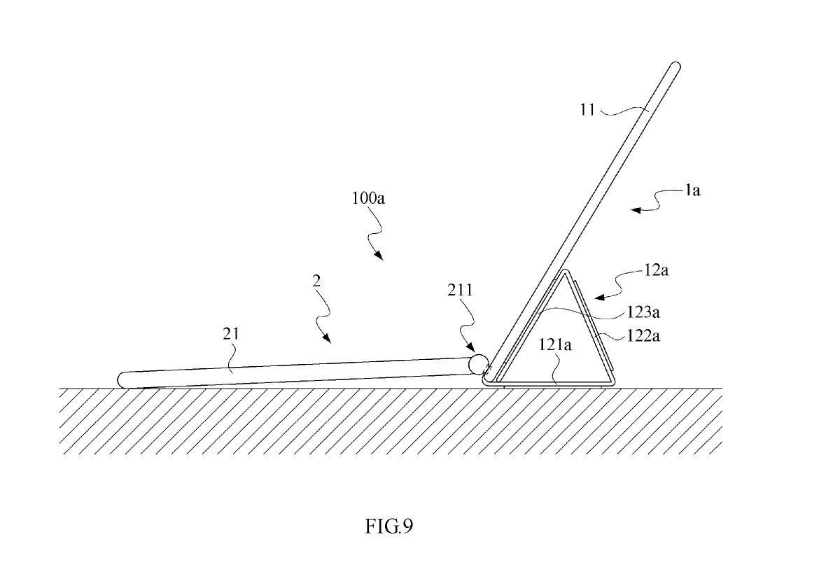

Please refer to FIG. 9. FIG. 9 is a planar view of a detachable electronic device in an embodiment. In an embodiment, as shown in FIG. 9, a detachable electronic device 100a includes the body 11 and a cover 12a. The cover 12a includes folding sections 121a, 122a and 123a.

Compared with the cover 12 in the above embodiment, the cover 12a does not include the hinge structure 124. Instead, the foldable connections between any two of the folding sections 121a, 122a and 123a are used to form a support structure to support the body 11. In the embodiment, the folding sections 121a, 122a and 123a are folded inwardly to allow the folding section 121a to be placed on the support surface and to allow the folding section 123a to abut against the body 11. Thus, the body 11 stands on the support surface via the support structure.

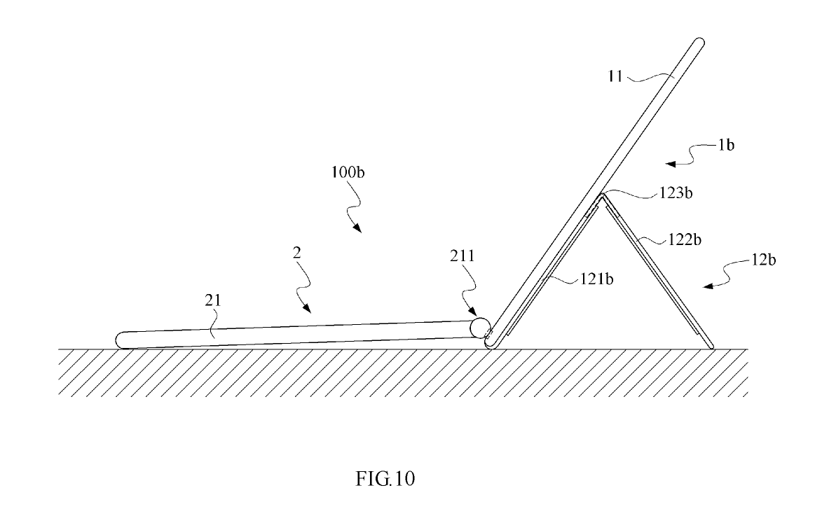

Please refer to FIG. 10. FIG. 10 is a planar view of a detachable electronic device in an embodiment. In an embodiment, as shown in FIG. 10, a detachable electronic device 100b includes the body 11 and a cover 12b. The cover 12b includes folding sections 121b and 122b and a hinge structure 123b.

Compared with the above-mentioned cover 12, the cover 12b abuts against the body 11 via the folding section 121b. The angle formed between the folding sections 121b and 122b of the cover 12b is kept via the torsional force from the hinge structure 123b (which is disposed between the folding sections 121b and 122b). Thus, the folding section 122b is supported on the support surface to support the body.

In sum, the detachable electronic device is magnetically attached and fixed to the peripheral unit via the pivot portion. The first connector is configured at the frame area of the body. The peripheral unit is magnetically attached to the frame area to make the connecting end portion raise up from the support surface, which facilitates the operation of the peripheral unit.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. A detachable electronic device, adapted to a cover with a plurality of folding sections, comprising:
a body, including a first surface and a second surface, a first connector is disposed at the first surface; and
a peripheral unit, detachably connected to the body and including a pivot portion, the pivot portion including:
a fixing pivot member; and
a magnetic pivot member, pivotally connected to the fixing pivot member and including a second connector;
wherein when the first connector is magnetically attached to the second connector and the body is supported by folding the folding sections of the cover, the pivot portion is raised up by a distance from a support surface against which the peripheral unit abuts.

2. The detachable electronic device according to claim 1, wherein when the first connector is magnetically attached to the second connector, the body is electrically connected to the peripheral unit.

3. The detachable electronic device according to claim 1, wherein the first surface includes a frame area, a frame magnetic element is disposed at the frame area, and a pivot magnetic element that corresponds to the magnetic pivot member is disposed at the frame magnetic element.

4. The detachable electronic device according to claim 1, wherein the cover includes a hinge structure, and the hinge structure is disposed between any two adjacent folding sections of the folding sections.

5. The detachable electronic device according to claim 1, wherein one of the folding sections is magnetic.
